(19) United States
(12) Patent Application Publication
(10) Pub. No.: US 2005/0216560 A1
(43) Pub. Date: Sep. 29, 2005

(54) Marketing using distributed computing

(76) Inventors: Seppo Pohja, Tampere (FI); Ari Potkonen, Kangasala (FI); Jari Mononen, Ruutana (FI)

Correspondence Address: CRAWFORD MAUNU PLLC, 1270 NORTHLAND DRIVE, SUITE 390, ST. PAUL, MN, 55120, US

(21) Appl. No.: 10/811,314

(22) Filed: Mar. 26, 2004

(51) Int. Cl. G06F 15/16

(52) U.S. Cl. 709/205

(57) ABSTRACT

A commercial activity can be marketed using distributed computing. Processor-executable code is sent to a plurality of users. The users are requested to run the processor-executable code on network-coupled computing arrangements accessible by the users. A distributed computing task is performed on each of the computing arrangements by running the processor-executable code on the computing arrangements. The distributed computing tasks work in concert to solve a computational problem. As a result of the distributed computing task, a user-perceivable experience is provided via the computing arrangements. The user-perceivable experience is configured for purposes of marketing the commercial activity.

### FIELD OF THE INVENTION

This invention relates in general to distributed computing, and more particularly to a method and apparatus for marketing using distributed computing.

### BACKGROUND OF THE INVENTION

There is a long history of conducting marketing activities using communications media. Print media probably has the longest history as a marketing tool, and print marketing is still popular and effective to this day. Twentieth century technical advances in communications such as radio and television have provided even more effecting channels of marketing. Of course, in order for electronic media marketing to have greater impact than print advertising, it did not suffice to simply imitate what was done in print advertising. Effective marketing that uses electronic medium (or any medium, for that matter) should take advantage of the unique aspects of that medium in order to create interest in the promoted products and services.

For example, radio advertising takes advantage of the audio format by using techniques such as voices of well-known personalities and “jingles.”Television advertising takes these concepts further by adding compelling images to the advertising. In both these examples, the most effective advertising not only uses the medium effectively to sell a product or service, but often adds additional factors that generate interest in the ad itself. Examples of such ads are commercials that pretend to be other commercials, ads that use cutting-edge humor, and ads that make an artistic statement, etc. Of course, an ad that generates interest in itself has the very beneficial side-effect of drawing attention to the product that the ad is promoting.

Computers and networks such as the Internet are a fairly new medium compared with radio and television. Nonetheless, advertising has been prevalent on the Internet nearly since its inception, and is still growing. Internet advertising often tends to mimic advertising in print, radio, and television media. For example, mass web mailings (“spam”) may be considered an electronic version of postal “junk” mail. Web site advertising includes ads that appear like print advertising (e.g., Web site banners) sometimes mixed with elements of sound and motion (video, animations, etc.).

Although Internet advertising is in its infancy, it is becoming apparent that that email or Web based ads are rarely more effective than counterparts in other media. Some reasons for this include the fact that the ads are easily overlooked. Efforts to increase visibility of Web based ads (e.g., popup windows, “adware”) often turn users against the advertisers and their products due to the annoyance caused by these devices. What is needed is a way to utilize the medium of computers and networks for marketing in such a way that entices users and does not alienate them. Such marketing should take advantage of the unique aspects of the technology so as to provide a positive and rewarding user experience. Such an experience will be invaluable in generating goodwill and genuine excitement about products and services.

### SUMMARY OF THE INVENTION

The present disclosure relates to a system, apparatus and method for marketing a commercial activity using distributed computing. In accordance with one embodiment of the invention, a method is provided for marketing a commercial activity using distributed computing. Processor-executable code is sent to a plurality of users. The users are requested to run the processor-executable code on network-coupled computing arrangements accessible by the users. A distributed computing task is performed on each of the computing arrangements by running the processor-executable code on the computing arrangements. The distributed computing tasks work in concert to solve a computational problem. As a result of the distributed computing task, a user-perceivable experience is provided via the computing arrangements. The user-perceivable experience is configured for purposes of marketing the commercial activity.

In accordance with another embodiment of the present invention, a computer-readable medium has instructions stored which are executable by a computing arrangement coupled to one or more computing entities via a network. The instructions are executable for steps that include performing a distributed computing task on a processor of the computing arrangement. The distributed computing task is performed in concert with the one or more computing entities to solve a computational problem. As a result of the distributed computing task, a user-perceivable experience is provided via an output of the computer arrangement. The user-perceivable experience is configured for purposes of promoting a commercial marketing activity.

In accordance with another embodiment of the present invention, a system includes a plurality of network-coupled computing arrangements. Each computing arrangement includes a processor coupled to a memory. The memory contains instructions configured to cause the processor to perform a distributed computing task on each computing arrangement. The distributed computing task operates in concert with other computing arrangements of the plurality of computing arrangements to solve a computational problem. The instructions are also configured to cause the processor to initiate a user-perceivable experience on each computing arrangement as a result of the distributed computing task. The user-perceivable experience is related to a commercial marketing activity.

In accordance with another embodiment of the present invention, a system for marketing a commercial activity includes means for sending processor-executable code to a plurality of users; means for requesting that the users run the processor-executable code on network-coupled computing arrangements accessible by the users; means for performing a distributed computing task on each of the computing arrangements by running the processor-executable code on the computing arrangements, the distributed computing tasks working in concert to solve a computational problem; and means for providing, as a result of the distributed computing task, a user-perceivable experience via the computing arrangements, the user-perceivable experience configured for purposes of marketing the commercial activity.

In more particular embodiments of the invention, the computational problem may include a processor-implemented creation of a product related to the commercial activity. The computational problem may include rendering of video, the user-perceivable experience may include the displaying of rendered frames on the computing arrangements, and, the commercial activity may include the creation of a motion picture.

In one configuration, the computing arrangements may perform the distributed computing tasks in a peer-to-peer arrangement. In another configuration, the computing arrangements may perform the distributed computing tasks in coordination with a centralized server arrangement. The distributed computing tasks may involve gathering input from the users of the computing arrangements. The distributed computing tasks may also involve storing data on the computing arrangements.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates a distributed computing system according to embodiments of the present invention;

FIG. 2 illustrates a peer-to-peer distributed computing system according to embodiments of the present invention;

FIG. 3 illustrates a distributed computing market scenario according to embodiments of the present invention;

FIG. 4 illustrates a procedure for marketing using distributed computing according to embodiments of the present invention;

FIG. 5 illustrates an example system environment of a distributed computing system according to embodiments of the present invention; and

FIG. 6 illustrates a computing arrangement for performing distributed computing functions according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a way of promoting marketing activities through the use of distributed computing. A distributed computing activity is disclosed that may be used to further two goals: (1) reduce costs in production of products and services where information processing has a significant economic role, and (2) enhance the marketing of the produced products or services, while reducing marketing costs. Depending on the implementation, the distributed computing activities may have other benefits, such as creating a community around the products or services, and/or creating a new customer interface. The distributed computing activity may be used in furtherance of various marketing activities and goals, including, strengthening brand-names, gathering demographics, and advertising products and services.

Distributed computing refers to a technique for the solution of large, processor-intensive problems. Distributed computing typically works by breaking a large problem into smaller problems that can be solved independently. Each small problem can be sent out to numerous computers to be solved, and the solutions to the small problems can be recombined into a solution of the larger problem. Use of distributed computing reduces information processing costs, since most of the costs (e.g., capital investment, operating expenses) are carried by the people who are contributing resources. The implementers of distributed systems therefore have no need to invest in large-scale computing resources, or to bear the costs associated with operating those resources.

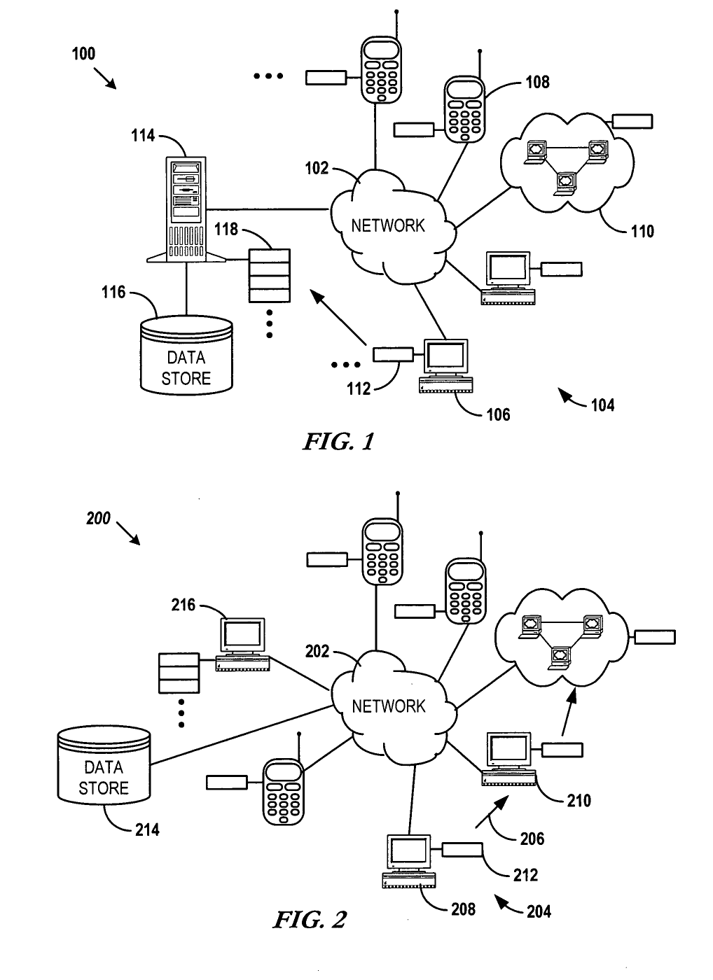

FIG. 1 illustrates a distributed computing system 100 according to embodiments of the present invention. The system 100 includes a network 102 that couples a plurality of computing arrangements 104. The computing arrangements 104 may include any type of data processing equipment, including a desktop computer 106 and a mobile phone 108. The computing arrangements 104 may also include other data processing entities, such as a cluster arrangement 110.

Each entity of the computing arrangements 104 includes a processing task, such as task 112 running on computer 106. The processing task 112 may include at least a set of processor-executable instructions that runs on the associated computer 106. The task 112 typically processes some type of data that may be included with the task 112 and/or retrieved elsewhere. For example, the task 112 may include a binary executable program that repeatedly retrieves via the network 102 a data set for processing. The executable program may perform calculations on the data set and send the computational results back out via the network 102.

In the illustrated distributed computing system 100, coordination of tasks may be provided by a centralized computing arrangement 114. The centralized computing arrangement 114 may include any number of processing units (e.g., servers), as well a data store 116. The centralized computing arrangement 114 may communicate with the distributed computing arrangements 104 for exchanging data for purposes of computation, scheduling, updating task instructions, task coordination messaging, etc. The centralized computing arrangement 114 may maintain a centralized task 118, which may include state and processed data of the distributed arrangements 104. The centralized task 118 is typically an end-goal of the system: a computational problem solved with the assistance of the distributed computing arrangements 104.

The distributed computing system 100 reflects a client-server architecture, wherein the distributed computing arrangements 104 communicate with a centralized processing unit 114. The client-server roles of these entities 104, 114 may change depending on the task. For example, the distributed arrangements 104 act as servers by providing computational services to the centralized processing unit 114 “client.” At other times, the centralized processing unit 114 acts as a server by providing organizational services (e.g., scheduling, assignment) to the distributed arrangement 104 “clients.”

There are other network organizational structures besides client-server that may be used in distributed computing. FIG. 2 illustrates an alternate distributed computing system 200 according to embodiments of the present invention. The distributed computing system 200 utilizes a peer-to-peer organization. As in most distributed systems, a plurality of computing arrangements 204 are coupled via a network 202. However, in the peer-to-peer arrangement 200 there may be no centralized authority.

Typically, each computing arrangement 204 in a peer-to-peer network may exchange data with any other computing arrangement 204. For example, in a peer-to-peer file sharing system (e.g., Gnutella), interconnected computing arrangements exchange search data with other peers in order to locate stored objects on the peers. Similarly, a peer-to-distributed computing arrangement 200 may exchange data and/or code between peers to accomplish a computational task. This is illustrated by the arrow 206 between computers 208 and 210. The computer 208 may pass a task 212, such as a piece of data or code for further processing by computer 210.

Although the peer-to-peer system 200 may rely on inter-peer communications, there may still be some centralization functionality utilized in the system 200. For example, a common data store 214 (e.g., file transfer protocol server) may be utilized by computing arrangements 204 for storage of globally accessible persistent data. Similarly, a controller arrangement 216 may provide coarse-grained control over the distributed system 200, such as defining some general guidelines for controlling peer-to-peer interactions, or for providing addresses of currently connected peers.

It will be appreciated that various implementations of client-server 100 and peer-to-peer 200 distributed systems are known in the art. For example, the SETI@home project is a client-server arrangement using programs that are widely distributed among Internet connected machines. The programs, which often take the form of screensavers, use spare computing time on the Internet machines to perform tasks that involve analyzing portions of radio telescope signals. Each task that is solved is returned to a central server to be added to the total signal analysis task. Many projects similar to SETI@home use similar client-server approach for solving problems in areas such as mathematics, drug design, genetics, cryptography, video rendering, and economic analysis.

Other technologies are available that allow distributed computing to take place in a peer-to-peer network. For example, JXTA™ technology is a set of open protocols that allow any network-connected device to communicate and collaborate in a peer-to-peer manner. Technologies such as JXTA may be extended to perform distributed computing tasks, including ad-hoc tasks that are initiated by peers. In another arrangement, peer-to-peer distributed computing can be used to solve problems that receive general guidance (starting parameters, central storage point for results, etc.) from a centralized source, even though the clients may self-organize various aspects of the solution, such as scheduling and division of work.

The illustrated client-server 100 and peer-to-peer 200 distributed systems may use any distributed computing technology known in the art to perform tasks. These tasks may be performed using parallel or serial calculations. Parallel calculations are similar to the SETI approach, where a task is broken into solution blocks that are solved in parallel by the distributed computers. A serial calculation is one in which one computer performs a calculation that alters a block of data, and the altered block of data is passed to a peer to which performs further calculations.

The distributed systems 100, 200, include additional, non-technical, aspects that provide advantages in many applications. For example, one goal behind distributed systems is to exploit free computing resources for an unfunded or underfunded project. Volunteers may contribute to such projects for various reasons, such as altruism, support for project goals, technical curiosity, or even the promise of some (usually nominal) amount of pay. However, in distributed systems 100, 200 of the present invention, the contributor may be offered an incentive that is based on a marketing goal of the system creator. In the peer-to-peer arrangement 200, the marketing may be for the benefit of a centralized entity, or for the benefit of the peers (e.g., peer-to-peer marketing). By presenting a connection between the distributed systems 100, 200 and a product, public interest and willingness to contribute to production is created.

Further, although the distributed systems 100, 200 may be directed to performing large calculations, this purpose may be equal to or subservient to another purpose, that of establishing a marketing presence with the contributors. The marketing presence may fulfill traditional goals of advertising (e.g., brand recognition) while creating a feeling of ownership and belonging to the contributors of the distributed systems 100, 200. Therefore, a commercial project that can make use of a distributed computing system, may accomplish two important goals—utilization of inexpensive distributed computing resources and enhancing marketing activity in relation to resource contributors.

The marketing is enhanced because there is opportunity to leverage various group behavioral incentives, including exclusivity, scarcity of opportunity (e.g., to be seen previewing and to contributing), feeling of belonging to a community, feeling of being useful and contributing, novelty, direct access to the consumer, ability to target groups that have screened themselves as the ones interested, etc. At the same time the marketing costs and investments can be reduced as the marketing medium is already there for the purposes or performing the distributed computing tasks.

From the consumer point of view, the use of a distributed computing client provides a very tangible proof of participation. Either a person participates or not, and those who participate can show it their computing device (e.g., or computer or mobile device screen). This creates a sense of belonging and, thus, a community. The sense of community can be further heightened in almost any way, including newsletters (electronic and/or paper), discussion rooms, gatherings (virtual and/or actual), etc.

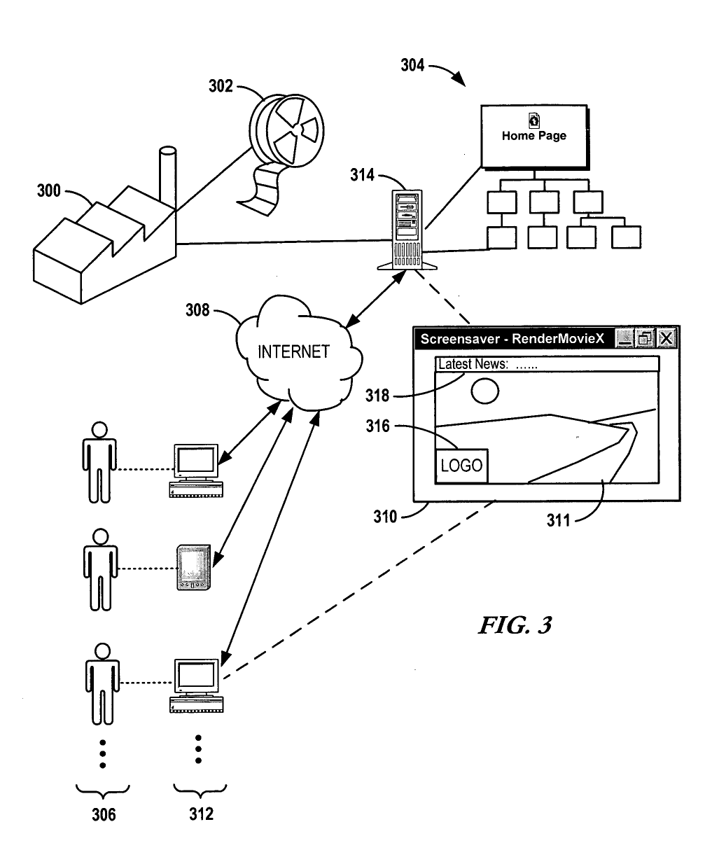

An example of how a distributed computing system according to embodiments of the present invention can achieve these marketing objectives is shown in FIG. 3. In this example, a movie studio 300 is in the process of creating a new movie 302 that relies heavily on computer processing. The movie 302 may be computer animated, or rely heavily on computer-generated effects. The studio 300 may announce to the public via a Web site 304 or other medium, that it is looking for volunteers 306 to contribute computer time to a movie currently in production. In return for contributing computer time, the volunteers 306 will see previews of the movie, e.g., movie frames that the computer is currently rendering.

The movie studio 300 may distribute via the Internet 308 (or other medium) one or more client programs 310 for executing instructions on volunteers' computers 312. The client program 310 may be, for example, a screensaver that shows a graphical display 311 when the computers 312 are idled for a certain amount of time. For reasons of security, scheduling, and propriety, the studio 300 may decide not to render important scenes in this way, and to include techniques such as redundant rendering of frames among different computers 312 to ensure data integrity and reduce effects of the system being compromised. Other techniques may also be used to ensure integrity of system data, such as encryption and Digital Rights Management (DRM). A computer system 314 controlled by the movie studio 300 may be responsible for dispatching computational tasks, enforcing security (e.g., authentication, authorization, data integrity), controlling the marketing logic (e.g., what content is visible to the user), and otherwise coordinating the client program(s) 310.

Although it will be appreciated that some movie studios may be able to afford massive computational hardware without resorting to a distributed system, the side benefits of utilizing such a technique is the interest generated among the volunteers 306, as well as interest generated with the public at large that hears about the effort. This interest can provide valuable pre-release publicity for a movie. Additional marketing devices may also be unobtrusively introduced with the program 310 for further marketing effect. For example, the program 310 may display the studio's logo 316 or a news banner 318 detailing news and information on the movie 302. The volunteers 306 will be less likely to be annoyed by such a marketing device compared to, for example, a pop-up browser window. The screensaver activates automatically at idle time, thus its appearance is not as jarring or unexpected as a popup window. The user could reasonably expect that at least a logo would be displayed with free software, so it should not be objectionable to add this and other elements that further enforce marketing goals.

Of course, the movie rendering case shown in FIG. 3 is only one example of using distributed computing in furtherance of marketing activities. Examples similar to that shown in FIG. 3 could include: an automaker performing distributed engineering analysis (e.g., finite element, computational fluid dynamics, etc.) of an automobile design to generate interest in a new model; a financial services company performing distributed economic pattern analysis of the stock market in order to generate interest in stock purchases; a software company using a massively parallel, distributed chess program playing against a human chess champion in order to generate interest in the software company; a weather analysis program gathers data (e.g., temperature, air pressure) from a user's mobile device whenever the user is outside to provide input to a distributed weather model to promote a weather-oriented media channel. Other applications of a distributed computing system according to embodiments of the present invention may include certain aspects of space exploration, logistic planning of services creating wide interest (e.g. transportation of goods: “See the stream of packages and your package in it”), etc.

In general, any system of distributed computational activity may be used to promote products and services. The computing activity may or may not be directly related to the marketing that is involved. The entity doing the marketing may only be an organizer and promoter of the activity, while the computation itself is performed for the benefit of a third party. For example, a drug company may write, promote, and/or distribute a screensaver program to perform distributed genetic research computation for a university research program. Although the drug company may not directly benefit from the research, the screensaver could contain a logo and other information relate to the drug company, thus promoting brand awareness and associating the company with a worthy cause.

The examples described in relation to FIG. 3 may be described as one-to-many scenarios, where one producer gets resources from multiple members of public. A distributed system could also be used in a scenario where there are multiple producers sharing the same technical infrastructure and contributor pool. For example, a third party may provide the technical infrastructure for a group of beneficiaries of the distributed computing resources. In another scenario, the roles of a producer and a member of the public may be interchangeable. For example, a given party can one day provide a resource (as a contributor) and another day consume them (as a producer of goods or services). Peer-to-peer organization that use the Gnutella protocol are an example of the latter situation. People can access the resources of the peer network based on the number of contributions made to the network. In a peer-to-peer implementation of a distributed system, this kind of “barter” mechanism may be included as an optional extension to a system that allows peer-to-peer marketing.

Although the examples presented so far deal with utilizing free or underutilized computational resources, it will be appreciated that gaining computational resources may not always be the end goal of the distributed system; the resources may just act as an enabler for a distributed activity. The computational resources made available by the members of public can be of almost any kind: storage space, CPU power, communication links, user feedback, etc.

For example, the distributed task may be to take advantage of human resources using the distributed computing to harvest the result of human activities as well as to promote marketing activities. For example, a movie studio might have a distributed script writing program that allows users to add to or modify portions of a proposed movie script. The script could be passed along serially, such that different persons add on to the contributions of the previous contributors. People could participate by making changes to the script and/or by voting on various versions that have been distributed. Although the activity of writing may be enabled by a computational program, the benefit derived is not necessarily the distributed computation, but rather the use of distributed human resources (writers, voters, etc.). Of course, the studio may or may not have any interest in the end product; the main purpose of the distributed task may be just to generate interest in an upcoming film.

It will be appreciated that various human resource intensive tasks could be accomplished using distributed computing while furthering market activities. For example, various artificial intelligence programs act as “classifiers” of data. A visual classifier might examine digitized images and determine the content of the images; a language classifier might analyze text and determine a meaning of the text. In some cases, the classifier may use reinforced learning, wherein the classifier makes a classification and then updates a learning database based on whether the classification was correct or not. Reinforced learning is often done with a training set, that is a set of classification data where the correct answers are known beforehand. However, as the training set grows very large, it becomes labor intensive to manually create training sets or check results applied to new sets of data. A developer of an artificial intelligence program could use a distributed training program where contributors are invited to see the classifier in action on untested data and rate the results. The contributions could be useful (assuming certain safeguards are put in place to screen purposefully wrong answers) in developing an artificial intelligence model, as well as promoting the end-result software that the user may be enticed to purchase.

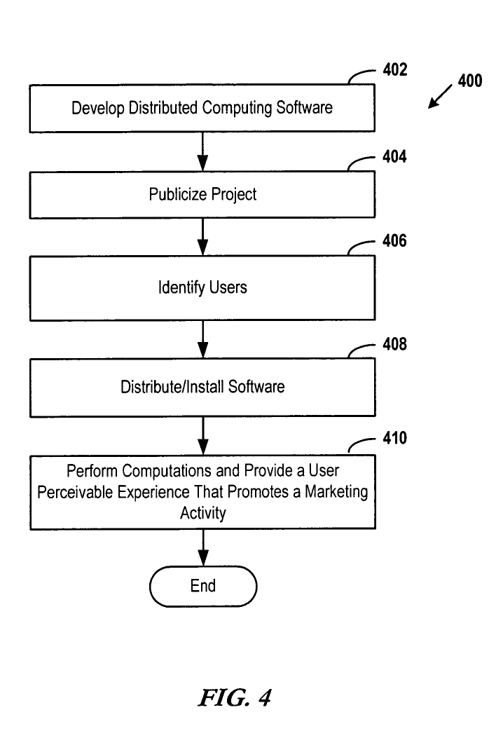

In reference now to FIG. 4, a flowchart 400 illustrates concepts of marketing using distributed computing according to embodiments of the present invention. First, distributed computing software is developed 402. This software may include a distributed component that includes computer executable instructions and data. The distributed component may run as a screen saver, a background process, an application or applet, an application plug-in, a library, etc. The instructions may be platform specific (e.g., compiled native binaries) or platform independent (e.g., Java™ objects). The software that is developed 402 may also involve setting up one or more servers and other architecture, such as establishing URL's, accounts, security mechanisms, etc.

Once the software is sufficiently developed 402, the project can be publicized 404 in order to inform contributors. Publicizing 404 the project promotes public interest and creates a willingness to contribute to the project. This may involve generating publicity in any manner known in the art, including advertising (print, television, Internet, etc.), word of mouth, posting on a Web site, posting announcements in Internet newsgroups, etc. The contributors are then identified 406 to ensure the public's ability to contribute the required computation resources. Mapping required resources to members of the public can be done using existing and well-understood technologies, such as that used by SETI@home.

Depending on the quantity and quality of contributors desired, this process of identifying users 406 can be as selective as needed. For the broadest possible coverage, any user may be able to contribute by downloading the necessary software. Where, for purposes of security, quality, etc., a more selective criterion is desired, the identification 406 of users may involve a registration process. The registration process can be used to identify and screen users before allowing access to the software.

Contributors that are identified 406 can then have the software distributed 408 to them. This may involve an Internet download, mailing of media (diskette, CD-ROM, etc.) or any other means known of distributing digital data. The distribution 408 also typically involves installing the software in one or more computing devices under control of the user. Once installed, the software runs 410 (usually repeatedly) thereby contributing computational resources, the computational resources provided by the public can be used for production of a product or a service. Typically, but not necessarily, the products or services that are being produced using these computational resources are also what is being marketed.

The software also provides a user-perceivable experience that promotes a marketing activity while the software is running 410. The user-perceivable experience provided by the software may involve the use of graphics, video, sound, text, control of devices, or any other manner of input/output known in the art. The experience may promote the marketing activity by showing a logo, showing an ad, displaying text, playing a sound, or activating any other media that may be associated with marketing a product or service. The very fact that the software originated from a commercial entity may be sufficient to enforce a marketing activity, although the connection between the commercial entity and the software is more effective if the connection is reinforced occasionally by activating some sort of user-perceivable experience.

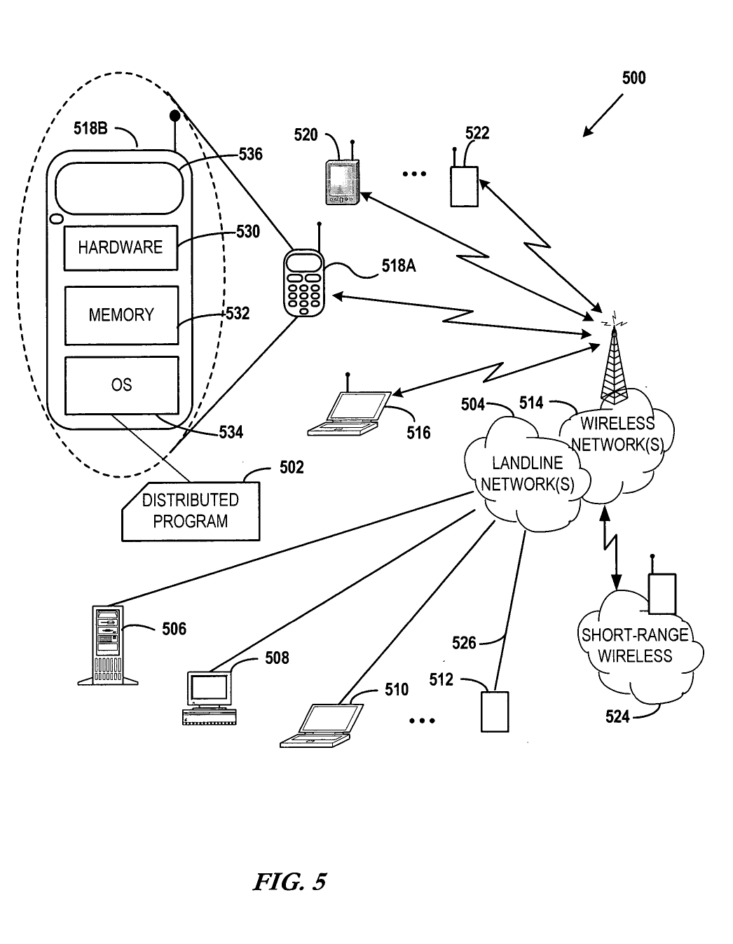

In reference now to FIG. 5, a representative system environment 500 is shown in which the principles of the present invention may be employed. In the representative system environment 500, a distributed-computation program 502 utilizes communications between target devices in any number of known manners. The distributed-computation program 502 may be distributed via networks of the system environment 500, or by other computer readable media. The distributed-computation program 502 may also utilize the system environment for communicating with other connected entities to exchange data and/or instructions for performing a distributed computing task according to embodiments of the present invention.

The distributed-computation program 502 may utilize any manner of data communication, include via a landline network(s) 504, which may include a Global Area Network (GAN) such as the Internet, one or more Wide Area Networks (WAN), Local Area Networks (LAN), and the like. Any computing device or other electronic device that supports data processing and communications may be the target system that utilizes the distributed-computation program 502, including servers 506, desktop computers 508 or workstations, laptop or other portable computers 510, or any other similar computing device capable of communicating via the network 504, as represented by generic device 512.

The distributed-computation program 502 may communicate via one or more wireless networks 514, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device can be configured utilize the distributed-computation program 502, such as laptop or other portable computers 516, mobile phones 518A and other mobile communicators, Personal Digital Assistants (PDA) 520, or any other similar computing device capable of communicating via the wireless network 514, as represented by generic device 522.

The distributed-computation program 502 may facilitate communication between devices using short-range wireless technologies 524, such as Bluetooth, Wireless Local Area Network (WLAN), infrared (IR), etc. The distributed-computation program 502 may also communicate using direct wired connections, such as depicted by connection path 526. The concepts described herein are applicable regardless of the manner in which the distributed-computation program 502 communicates or is distributed between the target devices.

An example of a target device that utilizes the distributed-computation program 502 is illustrated as the mobile phone 518B. The device 518B includes, for example, hardware 530 (including a processor, input/output devices, radio transceiver, etc.) coupled to a memory 532. The distributed-computation program 502 may be stored in the memory 532 and the instructions of the program executed on the processor via an operating system 534. The distributed-computation program 502 typically performs a distributed computation task in concert with other network entities, and provides an experience perceivable by the user of the device 518B. This user-perceivable experience may be, for example, a graphic or video shown in a display 536.

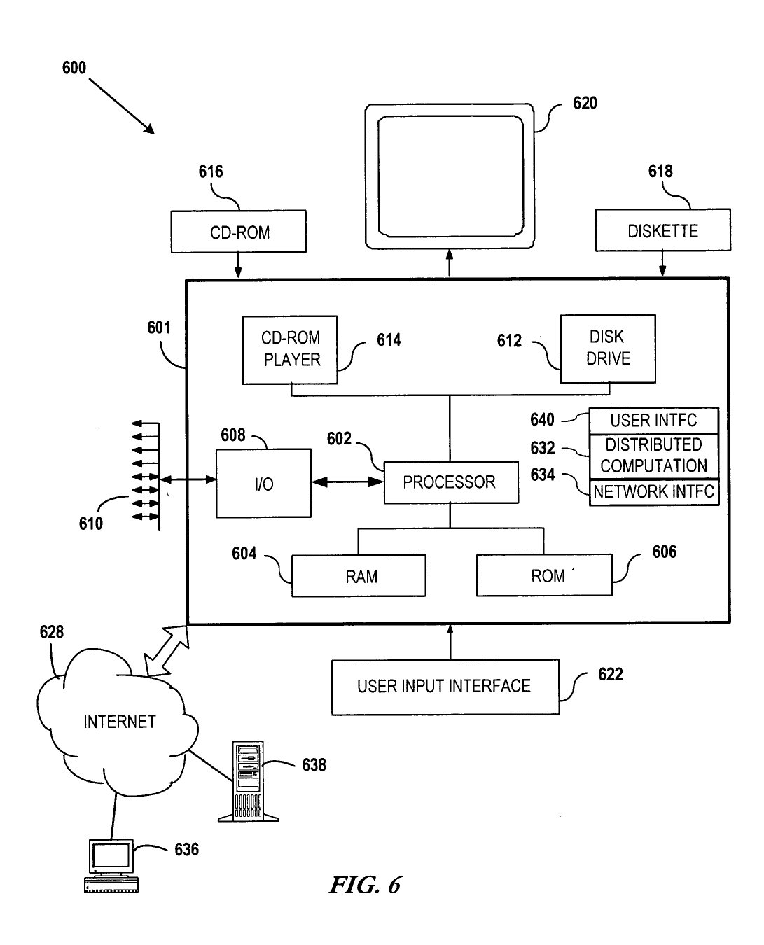

A distributed-computation program according to the embodiments of the present invention may be adapted to run on any type of computing structure known in the art. A computing structure 600 for running a distributed-computation program according to the embodiments of the present invention is illustrated in FIG. 6. The computing structure 600 is suitable for performing various activities of a distributed program, including data processing, network communications, and user interface.

The computing structure 600 includes a computing arrangement 601. The computing arrangement 601 may act a distributed-computation client, server, or peer. The computing arrangement 601 includes a central processor (CPU) 602 coupled to random access memory (RAM) 604 and read-only memory (ROM) 606. The ROM 606 may also include other types of storage media to store programs, such as programmable ROM (PROM), erasable PROM (EPROM), etc. The processor 602 may communicate with other internal and external components through input/output (I/O) circuitry 608 and bussing 610, to provide control signals and the like.

External data storage devices, such as databases, may be coupled to I/O circuitry 608 to facilitating distributed computing according to the present invention. Alternatively, such databases may be locally stored in the storage/memory of the computing arrangement 601, or otherwise accessible via a local network or networks having a more extensive reach such as the Internet 628. The processor 602 carries out a variety of functions as is known in the art, as dictated by software and/or firmware instructions.

The computing arrangement 601 may also include one or more data storage devices, including hard and floppy disk drives 612, CD-ROM drives 614, and other hardware capable of reading and/or storing information such as DVD, etc. In one embodiment, software for carrying out the operations in accordance with the present invention may be stored and distributed on a CD-ROM 616, diskette 618 or other form of media capable of portably storing information. These storage media may be inserted into, and read by, devices such as the CD-ROM drive 614, the disk drive 612, etc. The software may also be transmitted to computing arrangement 601 via data signals, such as being downloaded electronically via a network, such as the Internet 628. The computing arrangement 601 may be coupled to a display 620, which may be any type of known display or presentation screen, such as LCD displays, plasma display, cathode ray tubes (CRT), etc. A user-input interface 622 may be provided, including one or more user interface mechanisms such as a mouse, keyboard, microphone, touch pad, touch screen, voice-recognition system, etc.

The computing arrangement 601 may be coupled to other computing devices, such as landline and/or wireless terminals via a network, for Web service messaging. The server may be part of a larger network configuration as in a global area network (GAN) such as the Internet 628, which allows connections to the various landline and/or mobile devices.

The memory of the computing arrangement 601 may be used to store processor executable instructions for carrying out various distributed-computation tasks. For example, the computing arrangement 601may include a distributed-computation program 632 stored in memory (e.g., RAM 604). The distributed-computation program 632 may execute instructions on the processor 602 for performing calculations. The distributed-computation program 632 may include a network interface module 634 for exchanging data with other network entities. Network entities may include peers 636 (e.g., other entities running a compatible distributed computation program) and/or servers 638 (e.g., network entities that organize and/or store data for distributed computing entities).

The distributed-computation program 632 may also include a user interface module 640. The user interface module 640 can be used to provide a user-perceivable experience to further a marketing activity associated with the distributed-computation program 632. The user interface module 640 can send user-perceivable output to any output devices, including video displays 620, speakers, motors, illumination elements, etc. Similarly, the user interface module 640 can receive input from users related to the computational tasks of the program 632 or in support of a marketing activity. Input devices processed by the user interface module 640 may include microphones, keyboards, mice, trackballs, cameras, scanners, biometric devices, optical switches, mechanical switches, sensing elements (e.g., temperature, pressure, acceleration), etc.

The distributed-computation program 632 and associated modules 634, 640 may be provided in any form of machine executable instructions. For example, the program 632 may be provided as any combination of natively compiled executables, encoded modules running in an interpreter (e.g., Java™ program or applet), or text based instructions (e.g., scripts). The program 632 may be implemented as a screensaver, user application, daemon, or plug-in module to other application software. The program 632 may be incorporated in any combination of client-server, server-client, and peer-to-peer architectures.

The computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, mobile computing devices similarly include a processor, memory, a user interface, and data communication circuitry.

Hardware, firmware, software or a combination thereof may be used to perform the various functions and operations described herein of a distributed-computation program. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/tnodem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a distributed-computation system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

1. A method of marketing a commercial activity, comprising:
sending processor-executable code to a plurality of users;
requesting that the users run the processor-executable code on network-coupled computing arrangements accessible by the users;
running the processor-executable code on each of the computing arrangements to perform distributed computing tasks on the computing arrangement, the distributed computing tasks working in concert to solve a computational problem; and
providing, as a result of the distributed computing task, a user-perceivable experience via the computing arrangements, the user-perceivable experience configured for purposes of marketing the commercial activity.

2. The method of claim 1, wherein the computational problem comprises a processor-implemented creation of a product related to the commercial activity.

3. The method of claim 1, wherein the computational problem comprises rendering of video.

4. The method of claim 3, wherein the user-perceivable experience comprises displaying of rendered frames on the computing arrangements.

5. The method of claim 3, wherein the commercial activity comprises creation of a motion picture.

6. The method of claim 1, wherein two or more of the computing arrangements perform the distributed computing tasks in a peer-to-peer arrangement.

7. The method of claim 1, wherein the computing arrangements perform the distributed computing tasks in coordination with a centralized server arrangement.

8. The method of claim 1, wherein the distributed computing tasks include gathering input from the users of the computing arrangements.

9. The method of claim 1, wherein the distributed computing tasks include storing data on the computing arrangements.

10. A computer-readable medium having instructions stored thereon which are executable by a computing arrangement coupled to one or more computing entities via a network for performing steps comprising:
performing a distributed computing task on a processor of the computing arrangement, the distributed computing task performed in concert with the one or more computing entities to solve a computational problem;
providing, as a result of the distributed computing task, a user-perceivable experience via an output of the computer arrangement, the user-perceivable experience configured for purposes of promoting a commercial marketing activity.

11. The computer-readable medium of claim 10, wherein the computational problem comprises a processor-implemented creation of a product related to the commercial marketing activity.

12. The computer-readable medium of claim 10, wherein the computing arrangement is coupled to one or more of the computing entities in a peer-to-peer arrangement to perform the distributed computing task.

13. The computer-readable medium of claim 10, wherein the distributed computing task is performed in coordination with a centralized server arrangement.

14. The computer-readable medium of claim 10, wherein the distributed computing task includes gathering input from the user of the computing arrangement.

15. The computer-readable medium of claim 10, wherein the distributed computing task comprises storing data on the computing arrangement.

16. A system comprising:
a plurality of network-coupled computing arrangements, each computing arrangement including a processor coupled to a memory, the memory containing instructions configured to cause the processor to,
perform a distributed computing task on each computing arrangement, the distributed computing task operating in concert with other computing arrangements of the plurality of computing arrangements to solve a computational problem; and
initiate a user-perceivable experience on each computing arrangement as a result of the distributed computing task, wherein the user-perceivable experience is related to a commercial marketing activity.

17. The system of claim 16, wherein the computational problem comprises a processor-implemented creation of a product related to the commercial marketing activity.

18. The system of claim 16, wherein two or more of the computing arrangements are coupled in a peer-to-peer arrangement to perform the distributed computing task.

19. The system of claim 16, further comprising a network-coupled centralized server arrangement, wherein the computing arrangements perform the distributed computing task in coordination with the centralized server arrangement.

20. A computing arrangement coupled to one or more computing entities via a network, comprising:
a processor coupled to a memory and a user interface, the memory containing instructions configured to cause the processor to,
perform a distributed computing task operating in concert with other computing arrangements of the plurality of computing arrangements to solve a computational problem; and
initiate a user-perceivable experience on the user interface of the computing arrangement as a result of the distributed computing task, wherein the user-perceivable experience is related to a commercial marketing activity.

21. The computing arrangement of claim 20, wherein the computational problem comprises a processor-implemented creation of a product related to the commercial marketing activity.

22. The computing arrangement of claim 20, wherein the computing arrangement is coupled to one or more of the computing entities in a peer-to-peer arrangement to perform the distributed computing task.

23. The computing arrangement of claim 20, wherein the computing arrangement performs the distributed computing task in coordination with a centralized server arrangement.

24. The computing arrangement of claim 20, wherein the computing arrangement comprises a mobile terminal.

25. A system for marketing a commercial activity, comprising:
means for sending processor-executable code to a plurality of users;
means for requesting that the users run the processor-executable code on network-coupled computing arrangements accessible by the users;
means for performing a distributed computing task on each of the computing arrangements by running the processor-executable code on the computing arrangements, the distributed computing tasks working in concert to solve a computational problem; and
means for providing, as a result of the distributed computing task, a user-perceivable experience via the computing arrangements, the user-perceivable experience configured for purposes of marketing the commercial activity
